(19) United States
(12) Patent Application Publication
(10) Pub. No.: US 2009/0079353 A1
(43) Pub. Date: Mar. 26, 2009

(54) MAGNETRON DRIVE POWER SUPPLY

(75) Inventors: Shinichi Sakai, Nara (JP); Nobuo Shirokawa, Nara (JP); Haruo Suenaga, Osaka (JP); Hideaki Moriya, Nara (JP); Manabu Kinoshita, Nara (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/914,805

(22) PCT Filed: May 17, 2006
(86) PCT No.: PCT/JP2006/309814

§ 371 Date: Nov. 19, 2007

(30) Foreign Application Priority Data
May 25, 2005 (JP) 2005-152105

(51) Int. Cl. H05B 6/66; H01J 25/50

(52) U.S. Cl. 315/206

(57) ABSTRACT

An object of the invention is to provide a magnetron drive power supply for performing stable inverter operation and good in development efficiency.

According to the invention, the potential difference between emitter terminal potential (121) of a switching element (12) and minus terminal potential (101) of a rectifying device (1) can be minimized and stable switching operation and abnormal voltage detection can be realized. There can be provided an optimum magnetron drive power supply responsive to the power supply voltage and good in development efficiency because of unification of chassis, etc., with commonality of component placements, particularly ground connection positions (41) and filament output positions (42) of a magnetron drive power supply in the rated voltage range of 100 V to 120 V and a magnetron drive power supply in the rated voltage range of 200 V to 240 V.

### TECHNICAL FIELD

This invention relates to commonality of placement of current control means of a magnetron drive power supply having rated voltage of 100 V to 200 V of an inverter system and a magnetron drive power supply having rated voltage of 200 V to 240 V and placement of output means and ground of the two magnetron drive power supplies. It relates in particular to component placement of the magnetron drive power supply having rated voltage of 200 V to 240 V

### BACKGROUND ART

Hitherto, for this kind of magnetron drive power supply, detection with a shunt resistor of an input current section as an input power control target or the like has been proposed for miniaturization, etc., of the magnetron drive power supply. (For example, refer to patent document 1.) As for commonality of component placements of the magnetron drive power supply having rated voltage of 100 V to 200 V and the magnetron drive power supply having rated voltage of 200 V to 240 V, there is also commonality of placements of components from the reference point (for example, refer to patent document 2).

FIG. 6 shows a magnetron drive power supply in a related art described in patent document 1. As shown in FIG. 6, the magnetron drive power supply is made up of a rectifying device 1, a switching element 2, a shunt resistor 3, and a board 4 (the drawing is a transparent view from the solder plane).

FIG. 7 shows a magnetron drive power supply in a related art described in patent document 2. As shown in FIG. 7, the magnetron drive power supply is made up of a reference point 11, a first switching element 12, a second switching element 13, a step-up transformer 14, and a high voltage rectifying section 15.

Patent document 1: JP-A-2004-319134 (FIG. 5, etc.)
Patent document 2: JP-A-2000-195658 (FIG. 1, etc.)

### DISCLOSURE OF THE INVENTION

### Problems to be Solved by the Invention

However, in the configuration in the related art described in patent document 1, a long pattern intervenes between an emitter terminal 201 of the switching element 2 and one end 301 of the shunt resistor 3 and thus the effect of a large current flowing into the section is received and voltage drop between emitter potential 201 of the switching element 2 and a minus terminal 101 of the rectifying device 1 becomes large. Thus, a potential difference occurs in gate potential and ground of power control for the switching operation and therefore the switching operation and abnormal voltage detection may become unstable because of switching timing detection shift, etc.; this is a problem.

It is a first object of the invention to solve the problem in the related art described above and provide a magnetron drive power supply capable of performing stable switching drive as the potential difference between emitter potential of a switching element and a minus terminal of a rectifying device is minimized.

The configuration in the related art described above in patent document 2 has a problem of compatibility between the viewpoint of realizing a magnetron drive power supply having the rated voltage of 100 V to 120 V at low cost as the magnetron drive power supply in the range of 100 V to 120 V also has the two switching elements of the first (12) and second (13) switching elements and thus a plurality of switching elements of expensive IGBT, etc., must be used and the viewpoint of improvement of development efficiency by commonality of component placements of magnetron drive power supplies having the rated voltage of 100 V to 120 V and the rated voltage of 200 V to 240 V

It is a second object of the invention to solve the problem in the related art described above and provide a magnetron drive power supply with commonality of component placements, particularly the ground connection positions and the filament output positions of the magnetron drive power supply having a single switching element in the rated voltage range of 100 V to 120 V and the magnetron drive power supply having two switching elements in the rated voltage range of 200 V to 240 V and good in development efficiency because of unification of chassis, etc., of a microwave oven of counter top type of 100 V in Japan and a microwave oven of facility type below a hot plate of 200 V, etc.

### Means for Solving the Problems

To solve the problem in the related art described above, a magnetron drive power supply of the invention is a magnetron drive power supply characterized in that the proximity of an emitter terminal of a switching element and the proximity of a minus terminal of a rectifying device are directly connected by a shunt resistor.

Accordingly, voltage drop in a long pattern where a large current flows is eliminated and the potential difference between the emitter terminal potential of the switching element and the minus terminal potential of the rectifying device becomes the minimum.

As the magnetron drive power supply of the invention, in the magnetron drive power supply having a single switching element provided for the rated voltage class of 100 V to 120 V and the magnetron drive power supply having two switching elements provided for the rated voltage class of 200 V to 240 V, each ground position and a filament power supply position for heating a cathode of the magnetron are roughly matched.

Accordingly, the configuration involves commonality of component placements, particularly the ground connection positions and the filament output positions of the magnetron drive power supply in the rated voltage range of 100 V to 120 V having a single switching element and the magnetron drive power supply in the rated voltage range of 200 V to 240 V having two switching elements.

### ADVANTAGES OF THE INVENTION

With the magnetron drive power supply of the invention, the potential difference between the emitter terminal potential of the switching element and the minus terminal potential of the rectifying device can be made the minimum and stable switching operation and abnormal voltage detection can be realized. There can be provided the optimum magnetron drive power supply responsive to the power supply voltage and good in development efficiency because of unification of chassis, etc., with commonality of component placements, particularly the ground connection positions and the filament output positions in the magnetron drive power supply in the rated voltage range of 100 V to 120 V and the magnetron drive power supply in the rated voltage range of 200 V to 240 V.

### BRIEF DESCRIPTION OF THE DRAWINGS

FIG. 1 is a pattern drawing and a transparent component placement drawing of a magnetron drive power supply provided for rated voltage of 200 V to 240 V in a first embodiment of the invention.

FIG. 2 (a) is a circuit diagram of a magnetron drive power supply provided for rated voltage class of 100 V to 120 V in the first embodiment of the invention and FIG. 2 (b) is a circuit diagram of the magnetron drive power supply provided for rated voltage class of 200 V to 240 V

FIG. 3 is a side view of the main part of the magnetron drive power supply in the first embodiment of the invention.

FIG. 4 is a pattern drawing and a transparent component placement drawing of a magnetron drive power supply provided for rated voltage range of 100 V to 120 V in a second embodiment of the invention.

FIG. 5 is a side view of the main part of a step-up transformer in the second embodiment of the invention.

FIG. 6 is a pattern drawing of the main part of a magnetron drive power supply in a related art.

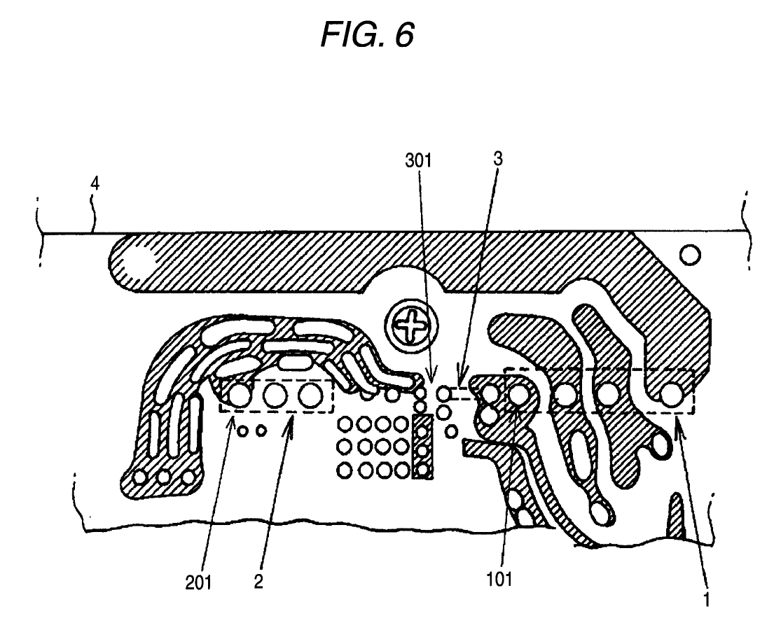

FIG. 7 is a component placement drawing of a magnetron drive power supply in a related art.

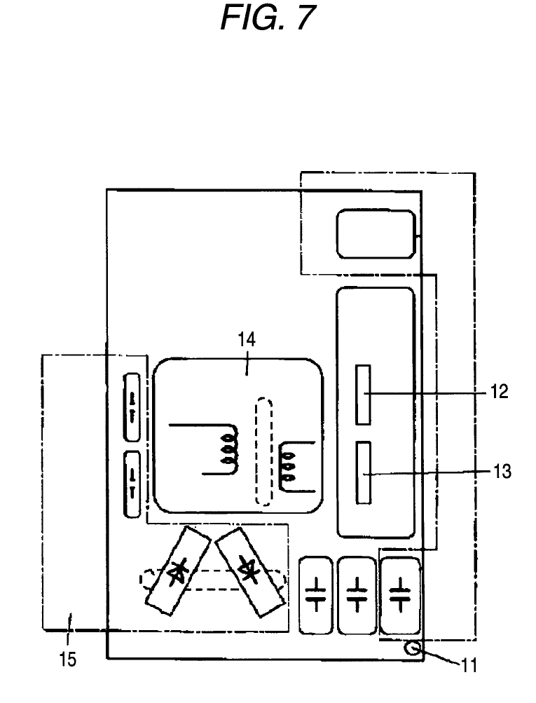

### DESCRIPTION OF REFERENCE NUMERALS

1 Rectifying device
2, 12, 13 Switching element
3 Shunt resistor
21 Unidirectional power supply section
22 Inverter section
23 Step-up transformer
24 High voltage rectifying section
25 Magnetron

### BEST MODE FOR CARRYING OUT THE INVENTION

In a first aspect of the invention, a magnetron drive power supply includes a unidirectional power supply section for converting a commercial power supply into a single direction, a rectifying device for performing full-wave rectification of AC power supply of the unidirectional power supply section, at least one semiconductor switching element, a radiator plate to which the rectifying device and the semiconductor switching element are attached, a shunt resistor intervened in series to a point where output current of the unidirectional power supply section can be measured, an inverter section for turning on/off the semiconductor switching element, thereby converting power from the unidirectional power supply section into high frequency power, a step-up transformer for boosting the output voltage of the inverter section, a high voltage rectifying section for performing voltage doubler rectification of the output voltage of the step-up transformer, and a magnetron for radiating the output of the high voltage rectifying section as an electromagnetic wave, characterized in that the proximity of an emitter terminal of the switching element and the proximity of a minus terminal of the rectifying device are directly connected by the shunt resistor, whereby voltage drop in a long pattern where a large current flows is eliminated and the potential difference between the emitter terminal potential of the switching element and the minus terminal potential of the rectifying device becomes the minimum, and switching drive and anomaly detection performance can be stabilized.

A second aspect of the invention is characterized by the fact that particularly the shunt resistor in the first aspect of the invention is placed roughly in parallel between the radiator plate and an extension of the rectifying device and the switching element, whereby the component mounting space is saved and particularly the magnetron drive power supply in the rated voltage range of 200 V to 240 V with a large number of components for controlling a plurality of switching elements and the magnetron drive power supply in the rated voltage range of 100 V to 120 V can be realized in roughly the same board size.

A third aspect of the invention is characterized by the fact that particularly in a magnetron drive power supply provided for a rated voltage class of 100 V to 120 V and a magnetron drive power supply provided for a rated voltage class of 200 V to 240 V, the shunt resistor in the first or second aspect of the invention becomes a length roughly proportional to each of the rated voltage classes, whereby the amplification degrees of minute signals from the shunt resistors can be roughly matched and problems of commonality of amplification circuits, saturation of an amplifier, etc., can be circumvented.

A fourth aspect of the invention is characterized by the fact that particularly in a magnetron drive power supply having two switching elements provided for the rated voltage class of 200 V to 240 V, the first switching element in any one of the first to third aspects of the invention connected to a minus terminal of the rectifying device is placed between the rectifying device and the second switching element, whereby it is made possible to connect the proximity of the emitter terminal of the first switching element and the proximity of the minus terminal of the rectifying device according to the appropriate length of the shunt resistor, and switching drive and anomaly detection performance can be stabilized.

A fifth aspect of the invention is characterized by the fact that particularly in the third or fourth aspect of the invention, in the magnetron drive power supply having a single switching element provided for the rated voltage class of 100 V to 120 V and the magnetron drive power supply having two switching elements provided for the rated voltage class of 200 V to 240 V, each ground position and a filament power supply position for heating a cathode of the magnetron are roughly matched, whereby commonality of attachment structures is made possible in the magnetron drive power supply having a single switching element provided for the rated voltage class of 100 V to 120 V and the magnetron drive power supply having two switching elements provided for the rated voltage class of 200 V to 240 V, and the optimum magnetron drive power supply responsive to the power supply voltage and good in development efficiency because of unification of chassis, etc., can be provided.

A sixth aspect of the invention is characterized by the fact that particularly the step-up transformer in the fifth aspect of the invention is integrated with the high voltage rectifying section, whereby the advantages of the fifth aspect of the invention can be provided easily.

A seventh aspect of the invention is characterized by the fact that particularly in the magnetron drive power supply in the fifth or sixth aspect of the invention, the ground part and the filament supply position are placed in portions positioned at both ends of one side of a board, whereby the output section to the magnetron, the power control section including the unidirectional power supply section and the inverter section, and the ground part can be isolated, and the same safe attachment structure can be realized in the magnetron drive power supply provided for the rated voltage class of 100 V to 120 V and the magnetron drive power supply provided for the rated voltage class of 200 V to 240 V.

An eighth aspect of the invention is characterized by the fact that particularly a current transformer is used in place of the shunt resistor in any one of the fifth to seventh aspects of the invention, whereby commonality of attachment structures is made possible and the optimum magnetron drive power supply responsive to the power supply voltage and good in development efficiency because of unification of chassis, etc., can be provided.

Embodiments of the invention will be discussed with reference to the accompanying drawings. The invention is not limited to the embodiments.

### FIRST EMBODIMENT

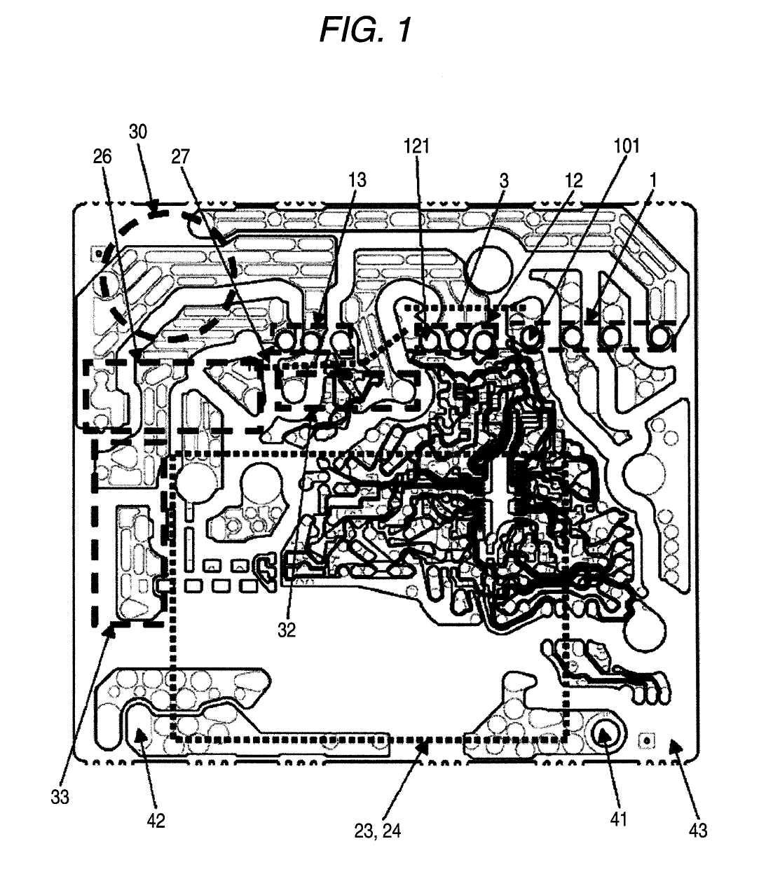

FIG. 1 is a pattern drawing of a magnetron drive power supply provided for rated voltage of 200 V to 240 V in a first embodiment of the invention and shows transparent component placement.

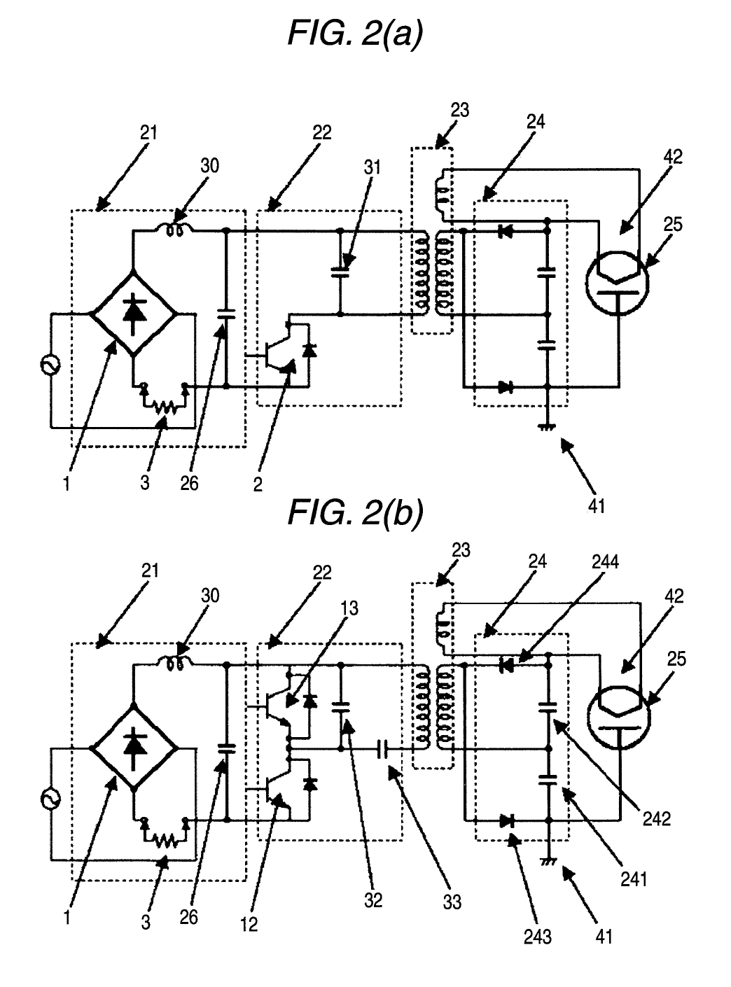

FIG. 2 (a) is a circuit diagram of a magnetron drive power supply provided for rated voltage class of 100 V to 120 V in the embodiment of the invention and FIG. 2 (b) is a circuit diagram of the magnetron drive power supply provided for rated voltage class of 200 V to 240 V.

In FIG. 2 (b), a magnetron drive power supply is made up of a unidirectional power supply section 21 for converting a commercial power supply into a single direction, a rectifying device 1 for performing full-wave rectification of AC power supply of the unidirectional power supply section 21, a shunt resistor 3 intervened in series to a point where output current of the unidirectional power supply section 21 can be measured, an inverter section 22 for turning on/off a first semiconductor switching element 12 and a second semiconductor switching element 13, thereby converting power from the unidirectional power supply section 21 into high frequency power, a step-up transformer 23 for boosting the output voltage of the inverter section 22, a high voltage rectifying section 24 for performing voltage doubler rectification of the output voltage of the step-up transformer 23, and a magnetron 25 for radiating the output of the high voltage rectifying section 24 as an electromagnetic wave.

The magnetron drive power supply is characterized by the fact that the proximity of an emitter terminal 121 of the first switching element 12 and the proximity of a minus terminal 101 of the rectifying device 1 are directly connected by the shunt resistor 3 in FIG. 1.

The operation and the function of the described magnetron drive power supply will be discussed below:

First, the input current flowing into the magnetron drive power supply flows from a smoothing capacitor 26 via the emitter terminal 121 of the first semiconductor switching element 12 and a jumper wire 27 into the shunt resistor 3 positioned in the proximity of the emitter terminal 121 of the first semiconductor switching element 12 and is fed back into the commercial power supply from the minus terminal 101 of the rectifying device 1 positioned in the proximity of the shunt resistor 3.

In the embodiment, the input current flowing into the magnetron drive power supply flows into the shunt resistor 3 positioned in the proximity of the emitter terminal 121 of the first semiconductor switching element 12 and is fed back into the commercial power supply from the minus terminal 101 of the rectifying device 1 positioned in the proximity of the shunt resistor 3 as described above, whereby the potential of the emitter terminal 121 of the first semiconductor switching element 12 and the potential of the minus terminal 101 of the rectifying device 1 which becomes ground potential of the inverter section 22 become only voltage drop occurring in the shunt resistor of low resistance, the potential difference between the emitter terminal potential of the switching element and the minus terminal potential of the rectifying device becomes the minimum, and switching drive and anomaly detection performance can be stabilized.

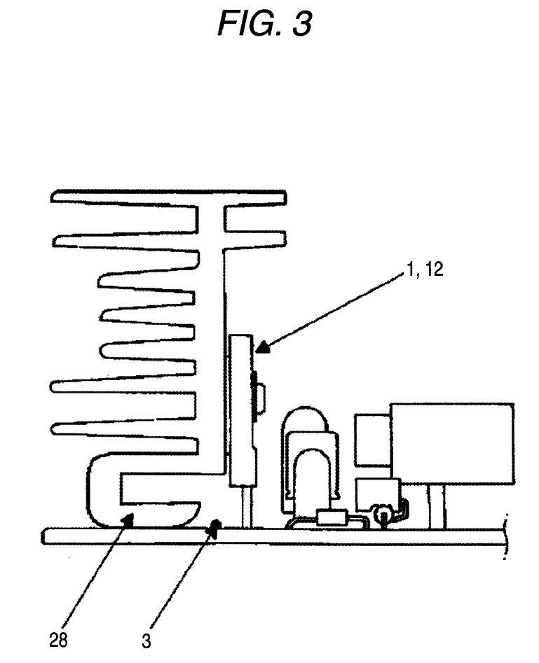

As shown in FIG. 3, the linear shunt resistor 3 of the embodiment is placed roughly in parallel between the end face of a leg part of a radiator plate 28 and an extension of arrangement of the terminals of the rectifying device 1 and the first semiconductor switching element 12, whereby the component mounting space is saved particularly in the magnetron drive power supply provided for the rated voltage of 200 V to 240 V with a large number of components, and particularly the magnetron drive power supply in the rated voltage range of 200 V to 240 V with a large number of components for controlling a plurality of switching elements and the magnetron drive power supply in the rated voltage range of 100 V to 120 V can be realized in roughly the same board size.

For example, a radio frequency heating apparatus such as a microwave oven mainly used on a counter top operates generally on 100 V in Japan. On the other hand, a radio frequency heating apparatus built in below a hot plate, etc., operating on 200 V is also proposed. Outputs of both radio frequency heating apparatus are almost the same regardless of the installation form and therefore the current flowing into the shunt resistor 3 becomes the relation

rated voltage×input current=constant

and thus print wiring board layout is designed so that the length of the shunt resistor 3 is 12.5 mm in the magnetron drive power supply provided for the rated voltage class of 100 V and is 25 mm in the magnetron drive power supply provided for the rated voltage class of 200 V, so that the lengths become such lengths roughly proportional to the rated voltage classes, whereby the amplification degrees of minute signals from the shunt resistors 3 can be roughly matched and problems of commonality of amplification circuits, saturation of an amplifier, etc., can be circumvented.

Further, as shown in FIG. 1, in the magnetron drive power supply having the two switching elements provided for the rated voltage class of 200 V to 240 V, the first switching element 12 connected to the minus terminal 101 of the rectifying device 1 is placed between the rectifying device 1 and the second switching element 13, whereby it is made possible to connect the proximity of the emitter terminal 121 of the first switching element 12 and the proximity of the minus terminal 101 of the rectifying device 1 according to the appropriate length of the shunt resistor 3, and according to the configuration where no potential difference occurs, unstable switching drive caused by timing detection shift, etc., can be prevented and an error of anomaly detection accompanying input voltage change caused by the potential difference between the ground potential of the inverter section 22 and the emitter potential 121 of the first switching element 12 can be prevented.

### SECOND EMBODIMENT

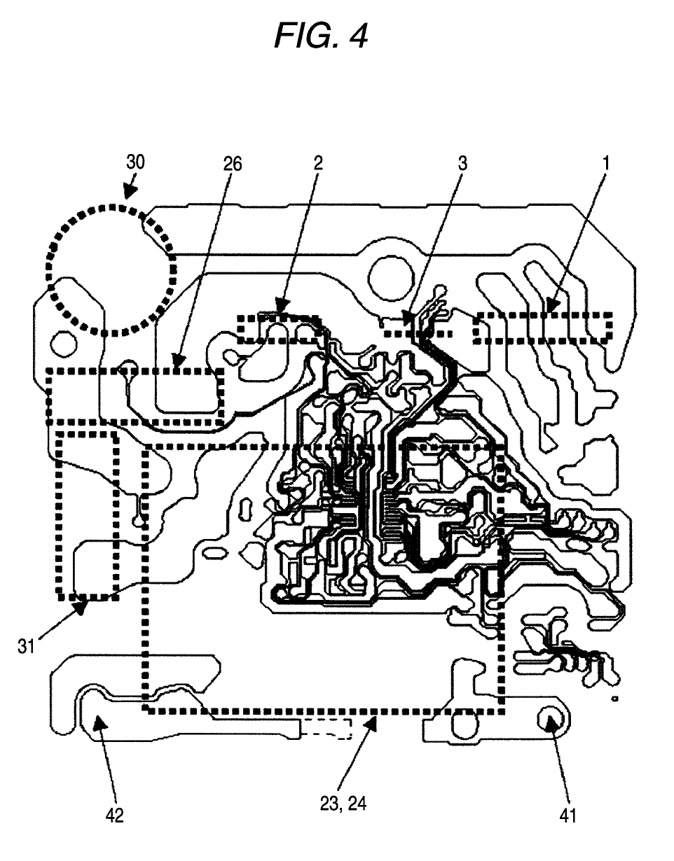

FIG. 4 is a pattern drawing of a magnetron drive power supply provided for rated voltage range of 100 V to 120 V in a second embodiment of the invention and shows transparent component placement.

In FIGS. 1 and 4, in a magnetron drive power supply having a single switching element 2 provided for the rated voltage class of 100 V to 120 V and a magnetron drive power supply having two switching elements 12 and 13 provided for the rated voltage class of 200 V to 240 V, each ground position 41 and a filament power supply position 42 for heating a cathode of the magnetron are roughly matched.

The operation and the function of the described magnetron drive power supply will be discussed below:

First, in FIGS. 1 and 4, in the magnetron drive power supply having the single switching element 2 provided for the rated voltage class of 100 V to 120 V and the magnetron drive power supply having the two switching elements 12 and 13 provided for the rated voltage class of 200 V to 240 V, each ground position 41 and the filament power supply position 42 for heating the cathode of the magnetron 25 are roughly matched, whereby the attachment configurations can be roughly matched and commonality of attachment structures is made possible in the magnetron drive power supply provided for the rated voltage class of 100 V to 120 V and the magnetron drive power supply provided for the rated voltage class of 200 V to 240 V; for example, there can be provided a magnetron drive power supply good in development efficiency because of unification of chassis of microwave ovens having rated voltages of 100 V of a counter top, etc., in Japan and built-in facility 200 V, development of 120 V rated voltage in the North American region and 240 V rated voltage in the Oceania region with the chassis, etc., and having the optimum configuration and manufacturing cost responsive to the power supply voltage.

As described above, in the embodiment, each ground position and the filament power supply position for heating the cathode of the magnetron are roughly matched, whereby the attachment configurations can be roughly matched and the magnetron drive power supply good in development efficiency and having the optimum configuration and manufacturing cost responsive to the power supply voltage can be provided.

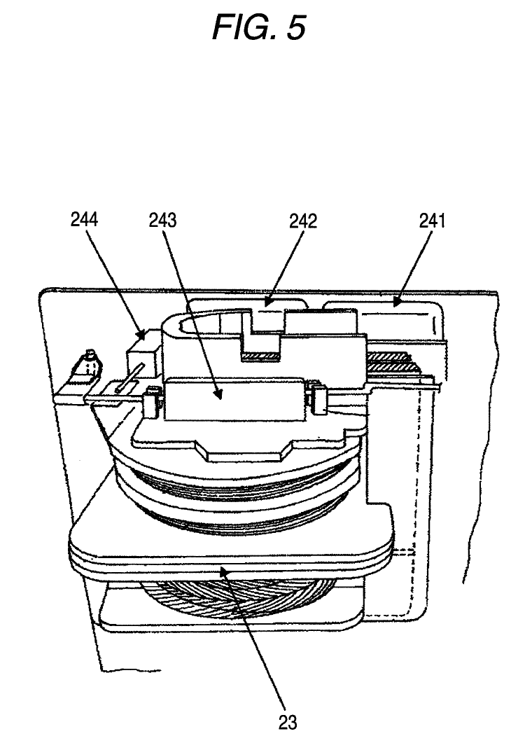

A step-up transformer 23 and a high voltage rectifying section 24 of the embodiment are integrated as in FIG. 5, whereby particularly the magnetron drive power supply having the two switching elements 12 and 13 provided for the rated voltage of 200 V to 240 V also has a large number of components and the high voltage rectifying section 24 is integrated with the step-up transformer 23, so that it is made possible to facilitate roughly matching each ground position and the filament power supply position for heating the cathode of the magnetron.

Further, as shown in FIGS. 1 and 4, in the magnetron drive power supply having the single switching element 2 provided for the rated voltage class of 100 V to 120 V and the magnetron drive power supply having the two switching elements 12 and 13 provided for the rated voltage class of 200 V to 240 V, each ground position 41 and the filament power supply position 42 for heating the cathode of the magnetron 25 are placed in portions positioned roughly at both ends of one side of a print wiring board 43, whereby the regions of the ground part 41, the filament power supply part 42, an inverter section 22, and a unidirectional power supply section 21 can also be isolated clearly in the magnetron drive power supply provided for the rated voltage of 200 V to 240 V and insulating performance and performance for EMC can be improved and a magnetron drive power supply for enabling the same attachment can be manufactured.

### THIRD EMBODIMENT

The features of the magnetron drive power supply provided for the rated voltage class of 100 V to 120 V and the magnetron drive power supply provided for the rated voltage class of 200 V to 240 V on the basis of the advantage of miniaturization using the shunt resistor 3 have been described. To use any other current detection element such as a current transformer in place of the shunt resistor 3, it is difficult to realize miniaturization of the power supply as compared with the case where the shunt resistor is used, but other advantages can be provided by upsizing the board size.

While the invention has been described in detail with reference to the specific embodiments, it will be obvious to those skilled in the art that various changes and modifications can be made without departing from the spirit and the scope of the invention.

This application is based on Japanese Patent Application No. 2005-152105 filed on May 25, 2005, which is incorporated herein by reference.

### INDUSTRIAL APPLICABILITY

As described above, with the magnetron drive power supply according to the invention, the potential difference between the emitter terminal potential of the switching element and the minus terminal potential of the rectifying device can be made the minimum and stable switching operation and abnormal voltage detection can be realized. There can be provided the optimum magnetron drive power supply responsive to the power supply voltage and good in development efficiency because of unification of chassis, etc., with commonality of component placements, particularly the ground connection positions and the filament output positions of the magnetron drive power supply in the rated voltage range of 100 V to 120 V and the magnetron drive power supply in the rated voltage range of 200 V to 240 V, so that the invention can also be applied to the use of a small-sized universal magnetron drive power supply with the power supply size unchanged according to the power supply voltage and the like.

1. A magnetron drive power supply comprising:
a unidirectional power supply section for converting a commercial power supply into a single direction;
a rectifying device for performing full-wave rectification of AC power supply of said unidirectional power supply section, at least one semiconductor switching element;
a radiator plate to which said rectifying device and said semiconductor switching element are attached;
a shunt resistor intervened in series to a point where output current of said unidirectional power supply section can be measured;
an inverter section for turning on/off said semiconductor switching element, thereby converting power from said unidirectional power supply section into high frequency power;
a step-up transformer for boosting the output voltage of said inverter section, a high voltage of said step-up transformer; and
a magnetron for radiating the output of said high voltage rectifying section as an electromagnetic wave,
wherein the proximity of an emitter terminal of said switching element and the proximity of a minus terminal of said rectifying device are directly connected by said shunt resistor.

2. The magnetron drive power supply as claimed in claim 1, wherein said shunt resistor is placed roughly in parallel between said radiator plate and an extension of said rectifying device and said switching element.

3. The magnetron drive power supply as claimed in claim 1, wherein a magnetron drive power supply provided for a rated voltage class of 100 V to 120 V and a magnetron drive power supply provided for a rated voltage class of 200 V to 240 V, said shunt resistor becomes a length roughly proportional to each of the rated voltage classes.

4. The magnetron drive power supply as claimed in claim 1, wherein a magnetron drive power supply having two switching elements provided for a rated voltage class of 200V to 240 V, the first switching element connected to a minus terminal of said rectifying device is placed between said rectifying device and the second switching element.

5. The magnetron drive power supply as claimed in claim 1, wherein the magnetron drive power supply having a single switching element provided for the rated voltage class of 100 V to 120 V and the magnetron drive power supply having two switching elements provided for the rated voltage class of 200 V to 240 V, each ground position and a filament power supply position for heating a cathode of said magnetron are roughly matched.

6. The magnetron drive power supply as claimed in claim 5, wherein said step-up transformer is integrated with said high voltage rectifying section.

7. The magnetron drive power supply as claimed in claim 5, wherein the ground part and the filament supply position are placed in portions positioned at both ends of one side of a board.

8. The magnetron drive power supply as claimed in claim 5, wherein a current transformer is used in place of said shunt resistor.
